(19) United States
(12) Patent Application Publication
(10) Pub. No.: US 2016/0358587 A1
(43) Pub. Date: Dec. 8, 2016

(54) DISPLAY DEVICE WITH TRACE LOSS COMPENSATION FUNCTION

(71) Applicant: Innolux Corporation, Miao-Li County (TW)

(72) Inventor: Ching-Wen Shih, Miao-Li County (TW)

(21) Appl. No.: 15/164,916

(22) Filed: May 26, 2016

(30) Foreign Application Priority Data
Jun. 8, 2015 (CN) 201510308938.4

(51) Int. Cl. G09G 5/18

(52) U.S. Cl. CPC G09G 5/18

(57) ABSTRACT

A display device including a plurality of scan lines and a scan driver is provided. The scan driver is coupled to the scan lines each being coupled to a plurality of pixels. The scan driver outputs a first enable signal to the first scan line of the scan lines at a first scan time within a frame time to enable the first scan line and outputs a second enable signal to the second scan line of the scan lines at a second scan time within the frame time to enable the second scan line. The voltage level of the first enable signal is different from that of the second enable signal.

This application claims the benefit of People's Republic of China application Serial No. 201510308938A, filed Jun. 8, 2015, the disclosure of which is incorporated by reference herein its entirety.

### TECHNICAL FIELD

The disclosure relates in general to a display device, and more particularly to a display device with trace loss compensation function.

### BACKGROUND

Along with the advance in the display technology, the market demand for large-sized panel also increases. In general, the panel includes a plurality of pixel rows, and the pixels in each pixel row are respectively connected to a scan line via a pixel transistor. When a scan line is enabled, each pixel transistor connected to the scan line will be turned on, such that the pixels of the pixel row can receive pixel data from the data line. Conversely, when the scan line is disenabled, each pixel transistor connected to the scan line will be turned off, such that the pixels of the pixel row cannot receive pixel data from the data line.

When a signal passes through traces, the voltage level of the signal will drop (that is, trace loss). If the trace between a scan line and its power end is too long, the signal of the scan line for controlling the on/off of each pixel transistor will be unable to turn on or turn off corresponding pixel row due to the trace loss.

Therefore, how to provide a display device capable of resolving voltage trace loss has become a prominent task for the industries.

### SUMMARY

The disclosure is directed to a display device with trace loss compensation function.

According to one embodiment, a display device is provided. The display device includes a plurality of scan lines each being coupled to a plurality of pixels, a scan driver coupled to the scan lines and a controller coupled to the scan driver. The scan driver outputs a first enable signal to a first scan line of the scan lines at a first scan time within a frame time to enable the first scan line, and outputs a second enable signal to a second scan line of the scan lines at a second scan time within the frame time to enable the second scan line. The controller, at the first scan time, outputs a first high power signal to the scan driver which outputs the first enable signal to enable the first scan line, and at the second scan time, outputs a second high power signal to the scan driver which outputs the second enable signal to enable the second scan line; wherein the first scan line on a panel is closer to the controller than the second scan line on the panel, the voltage level of the second high power signal is higher than that of the first high power signal, and the voltage level of the second enable signal is higher than that of the first enable signal.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 shows an example of a display device according to an embodiment of the invention.

FIG. 1A shows another example of a display device according to an embodiment of the invention.

FIG. 2 shows an example of a relationship diagram of high power signal vs low power signal before the controller adopts a trace loss compensation mechanism.

FIG. 3 shows an example of a relationship diagram of high/low power signal and enable/disenable signal vs frame time after the controller adopts a trace loss compensation mechanism.

FIG. 4 shows another example of a relationship diagram of high/low power signal and enable/disenable signal vs frame time after the controller adopts a trace loss compensation mechanism.

FIG. 5 shows another example of a relationship diagram of high/low power signal and enable/disenable signal vs frame time after the controller adopts a trace loss compensation mechanism.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

A number of embodiments are disclosed below for elaborating the invention. However, the embodiments of the invention are for detailed descriptions only, not for limiting the scope of protection of the invention. Furthermore, secondary or unimportant elements are omitted in the accompanying diagrams of the embodiments for highlighting the technical features of the invention.

The invention provides a display device capable of providing enable signals with different voltage levels to enable different scan lines within a frame time.

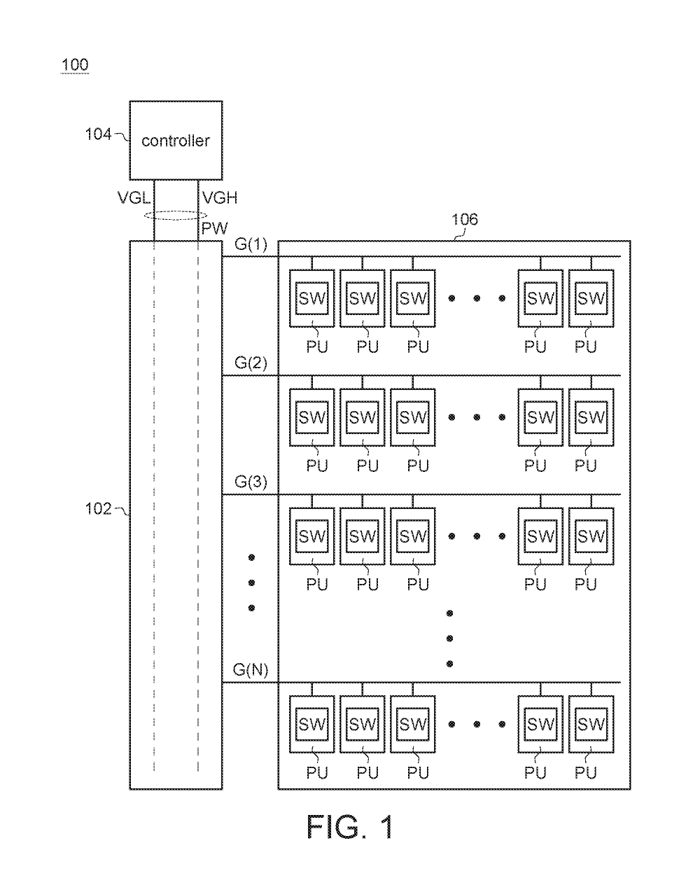

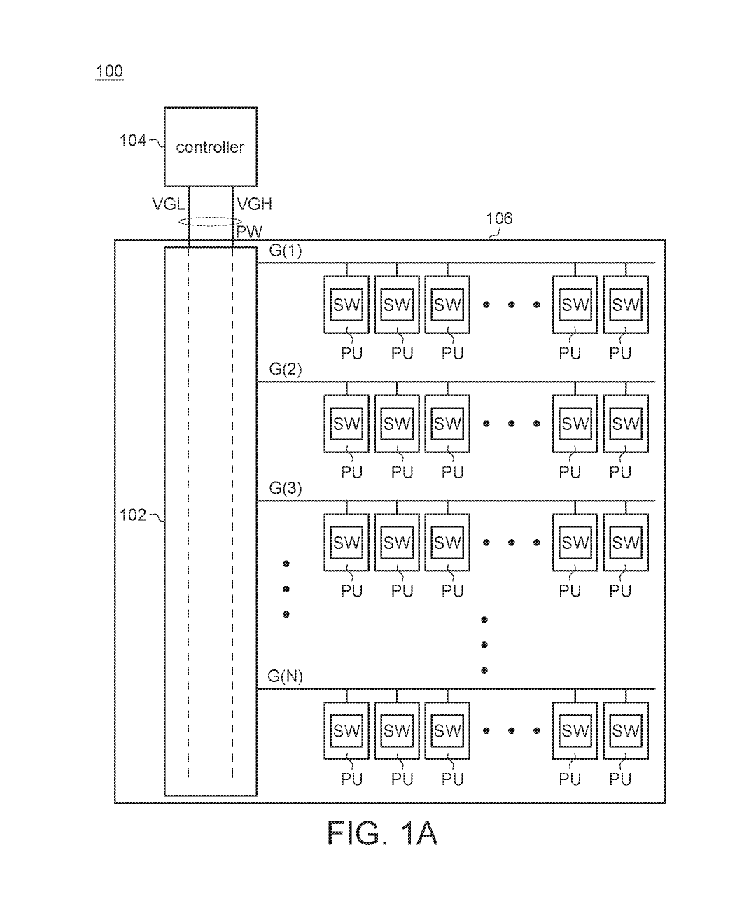

FIG. 1 shows an example of a display device 100 according to an embodiment of the invention. The display device 100 includes a plurality of scan lines G(1)˜G(N) and a scan driver 102, wherein N is an integer greater than 1. Each scan line is coupled to a plurality of pixels PU on the panel 106. The panel 106 includes a substrate (not shown). Each pixel PU is connected to a corresponding scan line through a switch element SW (such as a transistor). When a scan line receives an enable signal, the switch element SW is turned on, such that the pixel PU can receive pixel data from an external source. Meanwhile, the scan line is regarded as being enabled. Conversely, when a scan line receives a disenable signal, the switch element SW is turned off, such that the pixel PU cannot receive any pixel data from the external source. Meanwhile, the scan line is regarded as being disenabled.

The scan driver 102 is coupled scan lines G(1)˜G(N) and provides an enable/disenable signal to the scan lines G(1)˜G(N) to turn on/off a specific scan line. For example, the scan driver 102 sequentially provides an enable signal to the scan lines G(1)˜G(N) within a frame time to sequentially turn on the pixel rows corresponding to the scan lines G(1)˜G(N).

The scan driver 102 outputs a first enable signal to the first scan line of the scan lines G(1)˜G(N) at a first scan time within a frame time to enable the first scan line, and outputs a second enable signal to a second scan line of the scan lines G(1)˜G(N) at a second scan time within the frame time to enable the second scan line, wherein the voltage level of the first enable signal is different from that of the second scan line. Within a frame time, different scan times correspond to different scan positions. If the scan lines at the scan positions are affected by different levels of trace loss, the scan driver 102 can respectively output enable signals with proper voltage levels to the scan lines to correctly enable corresponding scan lines.

The display device 100 further includes a controller 104 coupled to the scan driver 102. The controller 104 can be realized by such as a pulse width modulation (PWM) integrated circuit or other circuits capable of providing a power signal to the scan driver 102 at different scan times. Although the scan driver 102 and the controller 104 are disposed outside the panel 106 as indicated in FIG. 1, the invention is not limited thereto. The scan driver 102 and/or the controller 104 can also be disposed on the panel 106 (such as in a non-display region on the panel 106). For example, the scan driver 102 can be implemented on the substrate of the panel 106, as shown in FIG. 1A. In such situation, the scan driver 102 and the panel 106 are on the same substrate.

In the example of FIG. 1, the controller 104 can provide a high power signal VGH and a low power signal VGL to the scan driver 102 through a power wire PW. In response to the high power signal VGH, the scan driver 102 can generate an enable signal capable of turning on the scan lines G(1)˜G(N). Conversely, in response to the low power signal VGL, the scan driver 102 can generate a disenable signal capable of turning off the scan lines G(1)˜G(N). Therefore, the controller 104 can be regarded as a power supply end to a scan line.

In an embodiment, the voltage level of the high power signal VGH (such as a positive voltage) is higher than that of the low power signal VGL (such as a negative voltage), but the invention is not limited thereto. In the present invention, the high power signal VGH refers to any power signal corresponding to the enable signal for enabling the scan lines, the low power signal VGL refers to any power signal corresponding to the disenable signal for disenabling the scan lines, and the high power signal VGH and the low power signal VGL depend on the application of the circuits.

In general, the larger the distance between the scan lines and their power supply end (that is, the controller 104) is, the larger the voltage trace loss will be. For example, suppose the controller 104 outputs a 30V high power signal VGH to a power wire PW at the very beginning. When the high power signal VGH is transmitted to the drive circuit of the scan driver 102 corresponding to the last scan line, that is, the scan line G(N), the voltage level of the high power signal VGH may drop to 20V only. Meanwhile, in response to the enable signal generated by the high power signal VGH, the voltage level of the scan driver 102 may be too low to turn on the pixel row of the scan line G(N).

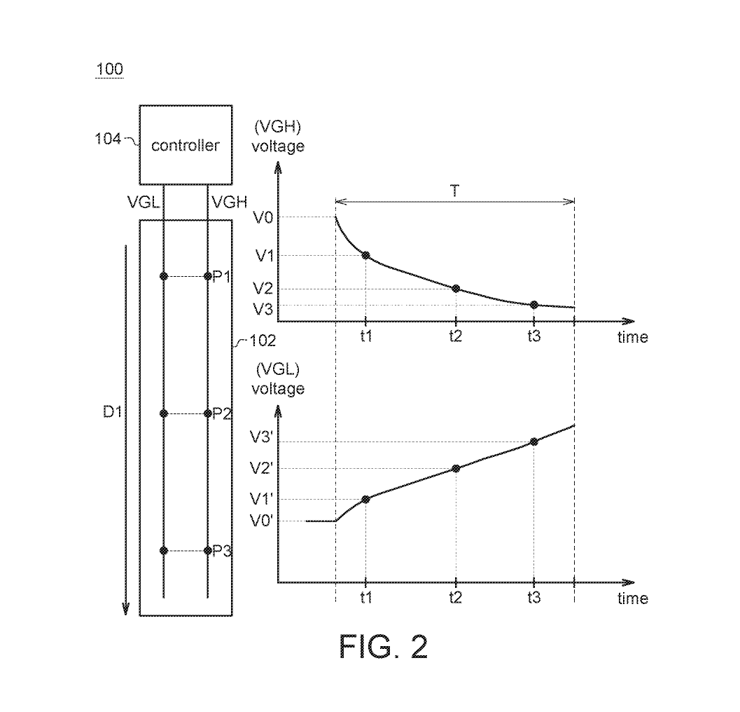

FIG. 2 shows an example of a relationship diagram of high power signal VGH vs low power signal VGL before the controller 104 adopts a trace loss compensation mechanism. In the example of FIG. 2, the scan driver 102 performs scanning in a top down manner within a frame time T. That s, within the frame time T, the scan driver 102 performs scanning according to the sequence of scan times, and sequentially turns of the scan lines G(1), G(2), . . . , G(N) along a direction D1. Therefore, the latter times the scan positions correspond to, the farther away from the controller 104 the scan positions will be. Let FIG. 2 be taken for example. At time t1, the corresponding scan position is P1; at time t2, the corresponding scan position is P2; at time t3, the corresponding scan position is P3. The power wire PW generates voltage loss (trace loss) with respect to the signal. For the high power signal VGH corresponding to the scan positions P1, P2, and P3. respectively, the voltage level sequentially drops to V1, V2, and V3 from the initial voltage level V0. For the low power signal VGL with a negative electrical potential, the voltage level sequentially increases to V1′, V2′, and V3′ from the initial voltage level V0′.

In response to the possible trace loss, the controller 104, within a frame time T, can determine the current scan position according to the scan time and adaptively provide a compensated high/low power signal to the scan driver 102 which can output an enable/disenable signal with proper voltage level.

Furthermore, the controller 104, at a first scan time within a frame time, can output a first high/low power signal to the scan driver 102 which outputs a first enable/disenable signal. The controller 104, at a second scan time within the frame time, can further output a second high/low power signal whose voltage level is different from that of the first high power signal to the scan driver 102 which outputs a second enable/disenable signal whose voltage level is different from that of the first enable/disenable signal.

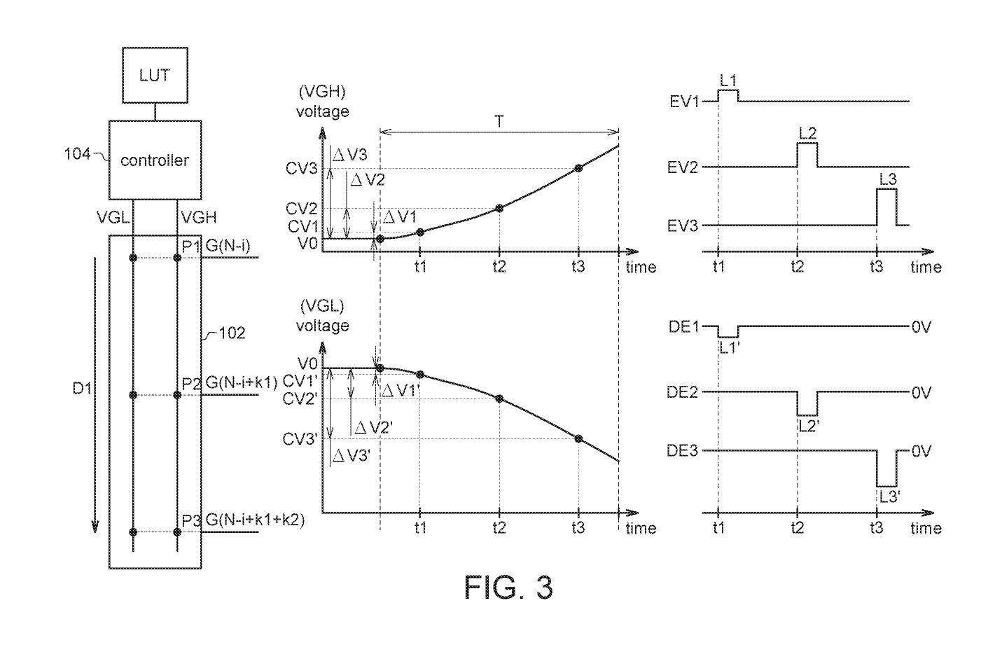

FIG. 3 shows an example of a relationship diagram of high/low power signal and enable/disenable signal vs frame time after the controller 104 adopts a trace loss compensation mechanism. In the example of FIG. 3, the controller 104, within a frame time T, outputs a progressively increasing high power signal VGH to compensate the trace loss according to the sequence of scan times. Relatively, the controller 104, within the frame time T, outputs a progressively decreasing low power signal VGL to compensate the trace loss according to the sequence of scan times. In an embodiment, the controller 104 sequentially outputs a compensated power signal with respect to each scan position. In another embodiment, the controller 104 sequentially outputs a compensated power signal with respect to one or more scan positions in a frame.

Let scan positions P1, P2, and P3 be taken for example. Suppose the scan position P1 corresponds to scan time t1, meanwhile, the voltage level of the high power signal VGH is CV1, which is higher than the initial voltage level V0 of the high power signal VGH by ΔV1. When scanning proceeds to the scan position P2, the corresponding scan time is t2, meanwhile, the voltage level of the high power signal VGH is increased to CV2, which is higher than the initial voltage level V0 by ΔV2. Likewise, the scan position P3 corresponds to scan time t3, and the voltage level of the high power signal VGH is increased to CV3, which is higher than the initial voltage level V0 by ΔV3.

Similarly, at the time t1 (corresponding to the scan position P1), the voltage level of the low power signal VGL is CV1′, which is lower than the initial voltage level V0′ of the low power signal VGL by ΔV1′. At the time t2 (corresponding to the scan position P2), the voltage level of the low power signal VGL is CV2′, which is lower than the initial voltage level V0′ by ΔV2′. At the time t3 (corresponding to the scan position P3), the voltage level of the low power signal VGL is CV3′, which is lower than the initial voltage level V0′ by ΔV3′.

The said voltage differences ΔV1, ΔV2, ΔV3 and ΔV1′, ΔV2′, ΔV3′ can be regarded as voltage compensations made for the high power signal VGH and the low power signal VGL by the controller 104 at the scan positions P1, P2 and P3. The said voltage compensations can be predetermined before the panel leaves the factory. Firstly, a test voltage can be applied to a power wire PW. Next, voltage values at different scan positions of the panel are measured. Then, a comparison between the measured voltage values and the test voltage value is made to obtain the voltage trace losses at the scan positions. Lastly, voltage compensations are determined according to the amounts of voltage trace loss. Suppose the voltage level of the test voltage is Vt, and the voltage value measured at a particular scan position is Vm, then the voltage trace loss at the scan position is (Vt−Vm). Meanwhile, the voltage compensation can be designed as (Vt−Vm). This information can be stored in a look-up table LUT which can be searched when the controller 104 outputs a power signal. The look-up table LUT can be stored in the controller 104 or in other memory circuits of the display device 100.

It can be understood that the invention can have different design of compensation for the high/low power signal. For example, the level of the compensated high power signal VGH can be higher than (V0+|Vt−Vm|), or the level of the compensated high power signal VGH can be determined by a function including two parameters: V0 and |Vt−Vm|. Relatively, the level of the compensated low power signal VGL can be lower than (V0−|Vt−Vm|), or the level of the compensated low power signal VGL can be determined by a function including two parameters: V0 and |Vt−Vm|. To summarize, any designs for determining the level of the compensated power signal according to the amount of voltage trace loss are still within the spirit of the invention.

As disclosed above, the look-up table LUT can store many compensation voltage values each corresponding to a scan position. Thus, during frame scanning, the controller 104 can obtain corresponding scan position of a scan line on the panel 106 according to the current scan time, and then search the look-up table LUT according to the scan position to generate the high/low power signal VGH/VGL corresponding to the scan line.

Refer to FIG. 3. If the scan driver 102 is coupled to the scan line G(N−i) at the scan position P1, coupled to the scan line G(N−i+k1) at the scan position P2, and coupled to the scan line G((N−i+k1+k2) at the scan position P3, then the scan driver 102 can output an enable signal EV1 with voltage level L1 in response to the high power voltage VGH with voltage level CV1 to enable the scan line G(N−i), wherein i, k1, k2 are positive integers. Then, the scan driver 102 can output an enable signal EV2 with voltage level L2 in response to the high power voltage VGH with voltage level CV2 to enable the scan line G(N−i+k1). Then, the scan driver 102 can output an enable signal EV3 with voltage level L3 in response to the high power voltage VGH with voltage level CV3 to enable the scan line G(N−i+k1+k2). In the present example, the voltage levels L1, L2 and L3 form a relationship: L3′<L2′<L1 However, the invention is not limited thereto, and the voltage levels of the enable signals exemplified above can be determined according to different amounts of trace loss.

Similarly, the scan driver 102 can output a disenable signal DE1 with voltage level L1 in response to the low power voltage VGL with voltage level CV1′ to disenable the scan line G(N−i), output a disenable signal DE2 with voltage level L2′ in response to the low power voltage VGL with voltage level CV2′ to disenable the scan line G(N−i+k1), and output a disenable signal DE3 with voltage level L3′ in response to the low power voltage VGL with voltage level CV3′ to disenable the scan line G(N−i+k1+k2). In the present example, the voltage levels L1, L2 and L3 form a relationship: L3′<L2′<L1′. However, the invention is not limited thereto, and the voltage levels of the enable signals exemplified above can be determined according to different amounts of trace loss.

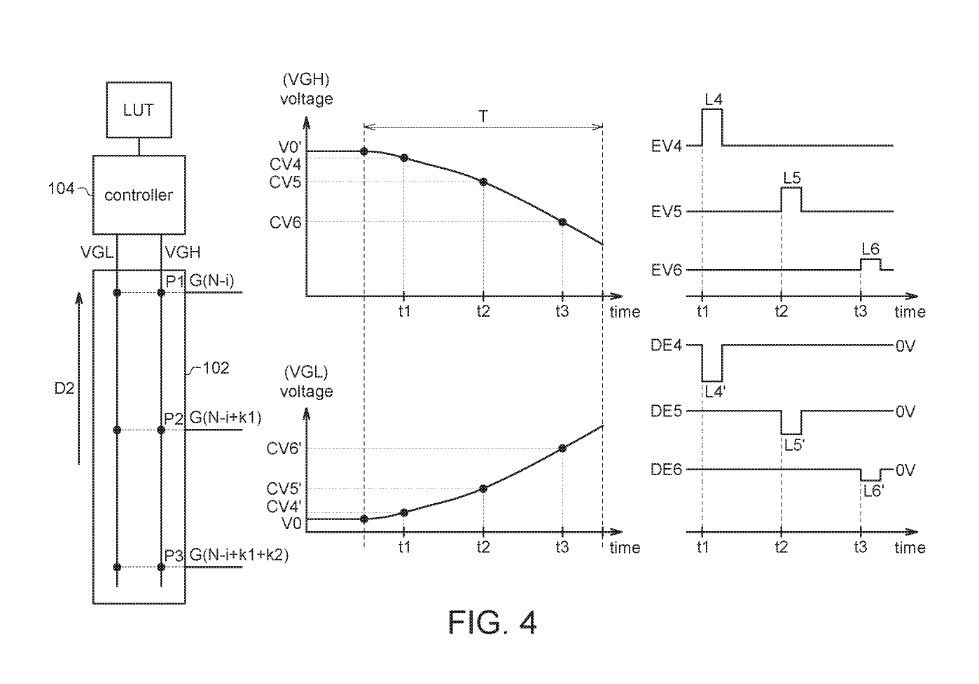

FIG. 4 shows another example of a relationship diagram of relevant control signals vs frame time T after the controller 104 adopts a trace loss compensation mechanism. The present embodiment is different from the previous embodiment in that the controller 104 of the present embodiment performs scanning in a bottom up manner. That is, within a frame time T. the controller 104 performs scanning according to the sequence of scan times, and the scan driver 102 sequentially turns of the scan lines scan lines G(N), G(N-1), . . . , G(1) along a direction D2. Therefore, the latter times the scan positions correspond to, the closer to the controller 104 the scan positions will be.

In the example of FIG. 4, within a frame time T, the controller 104 outputs a progressively decreasing high power signal VGH to compensate the trace loss according to the sequence of scan times. Relatively, within the frame time T, the controller 104 outputs a progressively increasing low power signal VGL to compensate the trace loss according to the sequence of scan times. Suppose the scan lines are sequentially enabled according to the above principle of compensation. At scan time ti the controller 104 can output a high power signal VGH with voltage level CV4 to the scan driver 102 which outputs an enable signal EV4 with voltage level L4 to enable the scan line G(N−i+k1+k2). At the scan time t2, the controller 104 can output a high power signal VGH with voltage level CV5 to the scan driver 102 which outputs an enable sig al EV5 with voltage level L5 to enable the scan line G(N−i+k1). At the scan time t3, the controller 104 can further output a high power signal VGH with voltage level CV6 to the scan driver 102 which outputs an enable signal EV6 with voltage level L6 to enable the scan line G(N−i). In the present example, the voltage levels form a relationship: L4>L5>L6.

Suppose the scan lines are sequentially disenabled according to the above principle of compensation. At the scan time t1, the controller 104 can output a low power signal VGL with voltage level CV4 to the scan driver 102 which outputs a disenable signal DE4 with voltage level L4′ to the scan line G(N−i). At the scan time t2, the controller 104 can output a low power signal VGL with voltage level CV5′ to the scan driver 102 which outputs a disenable signal DE5 with voltage level L5′ to disenable the scan line G(N−i+k1). At the scan time t3, the controller 104 can output a low power signal VGL with voltage level CV6′ to the scan driver 102 which outputs a disenable signal DE6 with voltage level L6′ to disenable the scan line G(N−i+k1+k2). In the present example, the voltage levels form a relationship: L4′<L5′<L6′. However, the invention is not limited thereto, and the voltage levels of the disenable signals can be determined according to the voltage level of the corresponding low power signal VGL.

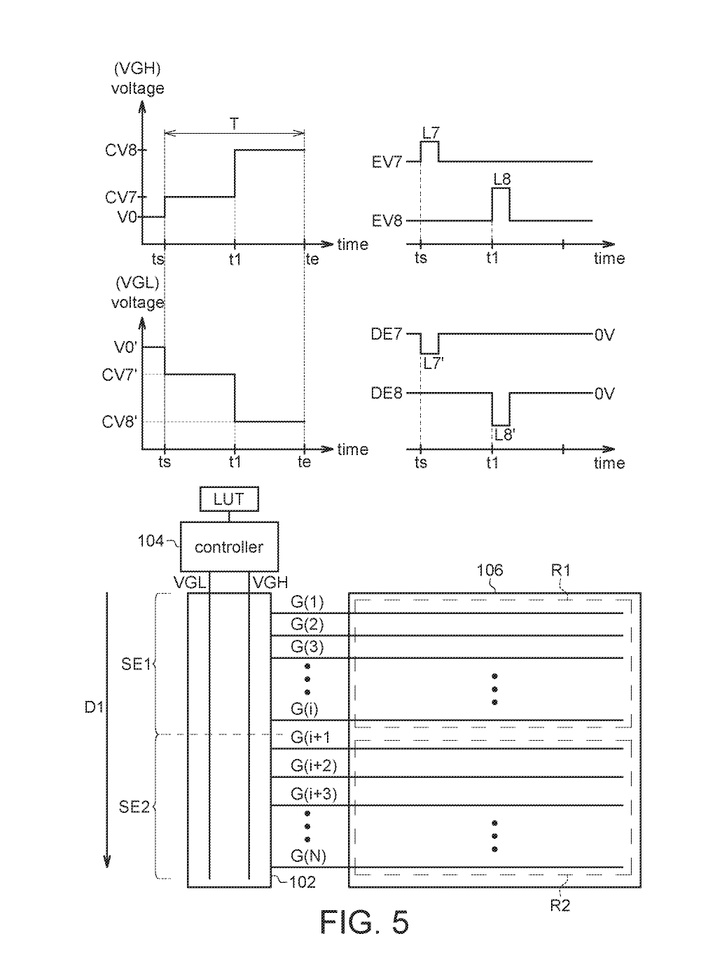

FIG. 5 shows another example of a relationship diagram of relevant control signals vs frame time after the controller 104 adopts a trace loss compensation mechanism. In the present embodiment, the controller 104 outputs the same power signal to the scan lines located in the same region on the panel 106. Let FIG. 5 be taken for example. The scan lines G(1)˜G(N) can be divided into two groups: the first group of scan lines G(1)˜G(i)) located in the first region R1 on the panel 106 and the second group of scan lines G(i+1)˜G(N) located in the second region R2 on the panel 106.

Let the top-down scanning be taken for example (that is, along a direction D1). The controller 104 applies a high power signal VGH with voltage level CV7 to the scan driver 102 at scan times ts˜t1 within the frame time T, wherein the scan times ts˜t1 correspond to a scan position interval SE1. Then, the controller 104 applies a high power signal VGH with voltage level CV8 to the scan driver 102 at scan times t1˜te, wherein the scan times t1˜te correspond to a scan position interval SE2. Since the scan lines G(i+1)˜G(N) corresponding to the scan position interval SE2 are located in the second region R2 on the panel 106 and farther away from the controller 104 than the first region R1, the scan lines G(i+1)˜G(N) are subject to a worse trace loss. In the present example, the voltage levels form a relationship as: CV8>CV7.

In response to the high power signal VHG, at the scan times t1˜te, the scan driver 102 sequentially outputs an enable signal EV7 to the first group of scan lines G(1)˜G(i) at the scan times ts˜t1 and sequentially outputs an enable signal EV8 to the second group of scan lines G(i+1)˜G(i+k1). The voltage level L7 of the enable signal EV7 is, for example, lower than the voltage level L8 of the enable signal EV8.

Similarly, suppose the scan lines are sequentially disenabled, the controller 104 can apply a low power signal VGL with voltage level CV7′ to the scan driver 102 at the scan times ts˜t1. Then, the controller 104 can apply a low power signal VGL with voltage level CV8′ to the scan driver 102 at the scan times t1˜te. The voltage level CV7′ is, for example, higher than the voltage level CV8′.

In response to the low power signal VHL, at the scan times ts˜t1, the scan driver 102 sequentially outputs a disenable signal DE7 with voltage level L7 to the first group of scan lines G(1)-G(i) and sequentially outputs a disenable signal DE8 with voltage level L8′ to the second group of scan lines G(i+1)˜G(i+k1). The voltage level L8′ is, for example, lower than the voltage level L7′.

It can be understood that the invention is not limited to the above exemplifications. For example, the number of groups of scan lines, and the arrangement and position of the scan lines on the panel can be designed according to system requirements. For example, the scan lines can be divided into more than two groups, and the number of scan lines in each group can be identical or different. Furthermore, the regions defined on the panel by the groups of scan lines can be staggered with each other, partly overlap each other, or do not overlap with each other at all.

To summarize, the display device of the invention is capable of determining the current scan position according to the scan time, and providing a loss compensated power signal to the scan driver, such that the voltage trace loss can be effectively compensated. Moreover, in response to the compensated power signal, the scan driver can output an adjusted disenable/enable signal with respect to the scan lines to correctly turn on/off the scan lines.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A display device, comprising:
a plurality of scan lines each being coupled to a plurality of pixels;
a scan driver coupled to the scan lines, wherein the scan driver outputs a first enable signal to a first scan line of the scan lines at a first scan time within a frame time to enable the first scan line, and outputs a second enable signal to a second scan line of the scan lines at a second scan time within the frame time to enable the second scan line; and
a controller coupled to the scan driver, wherein the controller, at the first scan time, outputs a first high power signal to the scan driver which outputs the first enable signal to enable the first scan line, and at the second scan time, outputs a second high power signal to the scan driver which outputs the second enable signal to enable the second scan line;
wherein the first scan line on a panel is closer to the controller than the second scan line on the panel, the voltage level of the second high power signal is higher than that of the first high power signal, and the voltage level of the second enable signal is higher than that of the first enable signal.

2. The display device according to claim 1, wherein the first scan time comes before the second scan time.

3. The display device according to claim 1, wherein the first scan time comes after the second scan time.

4. The display device according to claim 1, wherein within the frame time, the controller outputs a first low power signal to the scan driver which generates a first disenable signal to disenable the first scan line; the controller further outputs a second low power signal to the scan driver which generates a second disenable signal to disenable the second scan line;
wherein, the voltage level of the first low power signal is different from that of the second disenable signal, and the voltage level of the first low power signal is different from that of the second low power signal.

5. The display device according to claim 4, wherein the voltage level of the first low power signal is higher than that of the second low power signal, and the voltage level of the first low power signal is higher than that of the second disenable signal.

6. The display device according to claim 5, wherein the first scan time comes before the second scan time.

7. The display device according to claim 5, wherein the first scan time comes after the second scan time.

8. The display device according to claim 1, further comprising:
a look-up table storing a plurality of compensation voltage values, wherein each compensation voltage value corresponds to a scan position;
wherein, the controller obtains a first scan position of the first scan line on the panel according to the first scan time and searches the look-up table according to the first scan position to generate the first high power signal; the controller further obtains a second scan position of the second scan line on the panel according to the second scan time and searches the look-up table according to the second scan position to generate the second high power signal.

9. The display device according to claim 1, wherein within the frame time, the scan driver sequentially outputs the first enable signal to a first scan line group of the scan lines, and sequentially outputs the second enable signal to a second scan line group of the scan lines.

10. The display device according to claim 9, wherein the first scan line group is located in a first region on the panel, and the second scan line group is located in a second region on the panel.
